(19) United States
(12) Patent Application Publication
(10) Pub. No.: US 2013/0165268 A1
(43) Pub. Date: Jun. 27, 2013

(54) GOLF BALL MANUFACTURING METHOD AND GOLF BALL

(71) Applicants: Kanae TAJIMA, Chichibushi (JP); Takashi OHIRA, Chichibushi (JP)

(72) Inventors: Kanae TAJIMA, Chichibushi (JP); Takashi OHIRA, Chichibushi (JP)

(73) Assignee: BRIDGESTONE SPORTS CO., LTD, Tokyo (JP)

(21) Appl. No.: 13/607,237

(22) Filed: Sep. 7, 2012

(30) Foreign Application Priority Data
Dec. 26, 2011 (JP) 2011-282762

(51) Int. Cl. A63B 37/06; B05D 3/10

(52) U.S. Cl. 473/377; 427/301

(57) ABSTRACT

A method of manufacturing golf balls having a solid core formed of a rubber composition and a cover of one or more layer encasing the core is disclosed. The method includes the steps of forming a solid core, treating a surface of the core with an aqueous solution containing a haloisocyanuric acid and/or a metal salt thereof, washing the surface of the surface-treated core, and covering the washed surface of the core with a cover material. The manufacturing method lowers the burden on the environment, and the golf balls thus obtained have a good feel when struck, a good scuff resistance and a high durability to impact.

### CROSS-REFERENCE TO RELATED APPLICATION

This non-provisional application claims priority under 35 U.S.C. §119(a) on Patent Application No. 2011-282762 filed in Japan on Dec. 26, 2011, the entire contents of which are hereby incorporated by reference.

### BACKGROUND OF THE INVENTION

### Field of the Invention

The present invention relates to a method of manufacturing golf balls having a good durability to impact, a soft feel, and a cover with excellent scuff resistance. The invention also relates to golf balls obtained by such a manufacturing method.

Conventional golf balls generally have a core which consists primarily of a diene rubber and a cover structure which is obtained by injection-molding a material made primarily of an ionomer resin over the core. In recent years, attempts have been made to use resin materials other than ionomer resins as the cover material in order to improve the feel of the ball on impact and the scuff resistance on approach shots.

For example, JP-A 11-104273 discloses a solid golf ball having a multilayer structure composed of a solid core and an inner/outer two-layer cover encasing the core. The outer cover layer is composed primarily of a thermoplastic polyurethane elastomer. JP-A 10-219053 discloses the use of a polyamide elastomer as one component of a cover material for golf balls.

Such golf balls have a good feel and a high scuff resistance. However, compared with ionomer resins, the cover material has a poor compatibility with the diene rubber serving as the primary component of the core. As a result, when the ball is repeatedly struck, laminar separation tends to arise between the core surface and the adjoining cover layer.

In the golf ball industry, plasma treatment or corona discharge treatment is sometimes carried out as a way to increase the adherence of, for example, a coat of paint. However, when treatment of this type is used to improve adhesion between the core surface and the adjoining cover layer, because the functional groups introduced by such treatment are relatively small groups such as hydroxyl groups or carboxyl groups, and because these functional groups are introduced onto a soft rubber surface, when the molten, high-temperature cover resin covers the core surface during injection molding, most of the functional groups thus introduced end up migrating from the core surface to the core interior, making it impossible to achieve the expected adhesion-improving effects. In addition, JP-A 5-317459 discloses the treatment of a core surface with an aqueous solution containing active chlorine (e.g., chlorine, concentrated hydrochloric acid, metals salts of hypochlorous acid), but such solutions are difficult to handle and bad for the environment, in addition to which they are not as effective as the aforementioned plasma treatment.

Another approach involves, as described in JP-A 11-253581, primer treatment in which a solution containing a hot-melt resin as the key ingredient is coated onto the surface to which the cover material is to be bonded. However, the high-temperature molten resin that flows over the core surface during injection molding dissolves and carries away the hot-melt resin serving as the primer ingredient, causing undesirable effects such as resin bleedout to the parting line, which may adversely affect the ball durability and quality of appearance.

Also, in cases where the cover layer is formed by a heat compression molding or cast molding process using a thermoset polyurethane resin, the isocyanate included as an ingredient in the cover reacts with active hydrogen-containing functional groups derived from unsaturated carboxylic acids and/or metal salts thereof present in small amounts on the core surface. While this does improve adhesion with the core surface somewhat, the reaction takes a long time. Hence, such an approach has a far lower productivity than injection molding.

The applicant earlier disclosed, in JP-A 2009-131631, art for improving adherence between a golf ball core and a golf ball cover layer by using a haloisocyanuric acid-containing solution to surface-treat a core made of a rubber composition. However, because this art uses an organic solvent such as acetone as the solvent in the treatment solution, attention must be paid to the environmental impact.

Hence, even while addressing the desire that exists for golf balls which are endowed with both a good feel and a good scuff resistance, there remains room for improvement in achieving a high durability to impact. At the same time, the burden on the environment must also be taken into account.

### SUMMARY OF THE INVENTION

It is therefore an object of the present invention to provide a golf ball manufacturing method which, while reducing the burden on the environment, produces golf balls endowed with a good feel on impact, a good scuff resistance and a high durability to impact. A further object of the invention is to provide golf balls obtained by such a method.

The inventors have discovered that, in a method of manufacturing a multilayer golf ball having a solid core formed of a rubber composition and a cover of one or more layer encasing the core, by treating the core surface with an aqueous solution containing a haloisocyanuric acid and/or a metal salt thereof and subsequently covering the treated surface of the core with a cover material, adhesion between the core surface and the cover is greatly improved, making it possible to obtain a very high durability to impact. Moreover, by using water as the solvent in the treatment solution, the burden on the environment is reduced. The inventors have also found that, in such cases, by using a cover material composed primarily of a urethane resin or a polyamide resin to form the cover, outstanding solid golf balls endowed with an excellent feel on impact and an excellent scuff resistance compared with conventional golf balls can be obtained.

Accordingly, in a first aspect, the invention provides a method of manufacturing a golf ball having a solid core formed of a rubber composition and a cover of one or more layer encasing the core, which method includes the steps of forming a solid core, treating a surface of the core using a treatment solution which is an aqueous solution containing a haloisocyanuric acid and/or a metal salt thereof, washing the surface of the surface-treated core with a washing fluid, and forming a cover by covering the washed surface of the core with a cover material.

Prior to the surface treatment step, it is preferable to abrade the surface of the core.

The surface treatment step preferably uses, as the treatment solution, an aqueous solution containing dichloroisocyanuric acid or sodium dichloroisocyanurate.

The washing step preferably uses, as the washing fluid, either water or an aqueous solution containing a lower concentration of a haloisocyanuric acid and/or a metal salt thereof than the treatment solution used in the surface treatment step. In the washing step, the use of an aqueous solution containing dichloroisocyanuric acid or sodium dichloroisocyanurate as the washing fluid is more preferred.

The core is preferably formed of a rubber composition composed primarily of a diene rubber.

The cover typically has a layer adjoining the core, which layer is formed of a material composed primarily of one or more selected from the group consisting of thermoplastic polyurethane elastomers, thermoset polyurethane resins and polyamide elastomers.

The surface treatment step is preferably carried out by an immersion method.

The washing step is preferably carried out by an immersion method.

In a second aspect, the invention provides a golf ball having a solid core formed of a rubber composition and a cover of at least one layer encasing the core, which ball is manufactured by the method according to the first aspect of the invention.

(The term “and/or,” when used herein in a list of two or more items, means that any one of the listed items may be employed by itself, or any two or more of the listed items may be employed in combination. For example, if a solution is described as containing A and/or B, the solution may contain A alone, B alone, or A and B in combination.)

### DETAILED DESCRIPTION OF THE INVENTION

The objects, features and advantages of the invention will become more apparent from the following detailed description.

The inventive method of manufacturing golf balls can be advantageously used for producing golf balls having a solid core formed of a rubber composition and a cover of one or more layer encasing the core, and includes the steps of forming a solid core, treating a surface of the core with an aqueous solution containing a haloisocyanuric acid and/or a metal salt thereof, washing the surface of the surface-treated core, and covering the washed surface of the core with a cover material.

First, in the solid core-forming step, it is essential for the solid core to be formed of a rubber composition. The rubber composition may be suitably formulated in accordance with the required ball performance and is not subject to any particular limitation, although preferred use may be made of a rubber composition containing each of the following components:

(A) a base rubber containing from 60 to 100 wt % of a polybutadiene having a cis-1,4 bond content of at least 60%,
(B) an organic peroxide,
(C) an unsaturated carboxylic acid and/or a metal salt thereof, and
(E) an inorganic filler.

In addition, (D) an organosulfur compound may also be optionally included in the rubber composition.

In above component A, which is a base rubber containing from 60 to 100 wt % of polybutadiene having a cis-1,4 bond content of at least 60%, no particular upper limit is imposed on the content of cis-1,4 bonds included in the polybutadiene, although the content is typically at least 60%, preferably at least 80%, more preferably at least 90%, and most preferably at least 95%. At a cis-1,4 bond content in the polybutadiene below 60%, a good ball rebound may not be obtained. The polybutadiene has a molecular weight distribution Mw/Mn (where “Mw” represents the weight-average molecular weight, and “Mn” represents the number-average molecular weight) which, although not subject to any particular lower limit, may be set to typically at least 2.0, preferably at least 2.2, more preferably at least 2.4, and even more preferably at least 2.6. The molecular weight distribution Mw/Mn is also not subject to any particular upper limit, although it is advantageous to set this value to typically not more than 8.0, preferably not more than 7.5, more preferably not more than 4.0, and most preferably not more than 3.4. If the Mw/Mn of the polybutadiene is too small, the workability of the rubber composition may decrease. On the other hand, if Mw/Mn is too large, the ball rebound may decrease.

The above polybutadiene is not subject to any particular limitation, although the use of a polybutadiene synthesized with a rare-earth catalyst is preferred for achieving a high ball rebound. A known rare-earth catalyst may be used for this purpose. Exemplary rare-earth catalysts include those made up of a combination of a lanthanum series rare-earth compound, an organoaluminum compound, an alumoxane, a halogen-containing compound and an optional a Lewis base.

Examples of suitable lanthanide series rare-earth compounds include halides, carboxylates, alcoholates, thioalcoholates and amides of atomic number 57 to 71 metals.

Organoaluminum compounds that may be used include those of the formula AlR¹R²R³ (wherein R¹, R² and R³ are each independently a hydrogen or a hydrocarbon residue of 1 to 8 carbons).

Preferred alumoxanes include compounds of the structures shown in formulas (I) and (II) below. The alumoxane association complexes described in Fine Chemical 23, No. 9, 5 (1994), J. Am. Chem. Soc. 115, 4971 (1993), and J. Am. Chem. Soc. 117, 6465 (1995) are acceptable in this case.

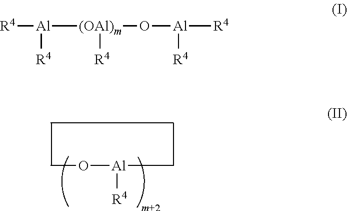

In formulas I and II, R⁴ is a hydrocarbon residue of 1 to 20 carbon atoms, and the letter m is 2 or a larger integer.

Examples of halogen-containing compounds that may be used include aluminum halides of the formula AlXₙR₃₋ₙ (wherein X is a halogen atom; R is a hydrocarbon residue of 1 to 20 carbons, such as an alkyl, aryl or aralkyl; and the letter n is 1, 1.5, 2 or 3); strontium halides such as Me SrCl, Me₂SrCl₂, MeSrHCl₂ and MeSrCl₃ (wherein “Me” represents a methyl group); and other metal halides such as silicon tetrachloride, tin tetrachloride and titanium tetrachloride.

The Lewis base may be used to form a complex with the lanthanide series rare-earth compound. Illustrative examples include acetylacetone and ketone alcohols.

In the practice of the invention, the use of a neodymium catalyst in which a neodymium compound serves as the lanthanide series rare-earth compound is particularly advantageous because it enables a polybutadiene rubber having a high cis-1,4 bond content and a low 1,2-vinyl bond content to be obtained at an excellent polymerization activity. Preferred examples of such rare-earth catalysts include those mentioned in JP-A 11-35633.

When the butadiene is polymerized in the presence of a rare-earth catalyst which uses a lanthanum series rare-earth compound, in order to have the cis bond content and the molecular weight distribution Mw/Mn fall within the above-indicated ranges, it is desirable to set the molar ratio of the butadiene to the lanthanum series rare-earth compound (butadiene/lanthanum series rare-earth compound) to preferably from 1,000 to 2,000,000, and more preferably from 5,000 to 1,000,000, and to set the molar ratio of AlR¹R²R³ to the lanthanum series rare-earth compound (AlR¹R²R³/lanthanum series rare-earth compound) to preferably from 1 to 1,000, and more preferably from 3 to 500. In addition, it is desirable to set the molar ratio of the halide compound to the lanthanum series rare-earth compound (halide compound/lanthanum series rare-earth compound) to preferably from 0.1 to 30, and more preferably from 0.2 to 15. It is also desirable to set the molar ratio of the Lewis base to the lanthanum series rare-earth compound (Lewis base/lanthanum series rare-earth compound) to preferably from 0 to 30, and more preferably from 1 to 10. Polymerization may be carried out by bulk polymerization or vapor phase polymerization, either with or without the use of solvent, and at a polymerization temperature in the range of generally from −30 to 150° C., and preferably from 10 to 100° C.

The polybutadiene used in the invention has a Mooney viscosity (ML₁₊₄ (100° C.)) which, although not subject to any particular lower limit, may be set to preferably at least 20, more preferably at least 30, and even more preferably at least 35. The Mooney viscosity of the polybutadiene also has no particular upper limit, but is preferably not more than 140, more preferably not more than 120, even more preferably not more than 100, and most preferably not more than 80. At a Mooney viscosity outside of the above range, the workability may become poor and the ball rebound may decrease.

The term “Mooney viscosity” used herein refers to an industrial indicator of viscosity (JIS K6300) as measured with a Mooney viscometer, which is a type of rotary plastometer. The unit symbol used is ML₁₊₄ (100° C.), where “M” stands for Mooney viscosity, “L” stands for large rotor (L-type), “1+4” stands for a pre-heating time of 1 minute and a rotor rotation time of 4 minutes, and “100° C.” indicates that measurement was carried out at a temperature of 100° C.

The polybutadiene may be obtained by polymerization using the above-described rare-earth catalyst, followed by the reaction of active end groups on the polymer with a terminal modifier.

Known terminal modifiers may be used for this purpose. Suitable terminal modifiers are exemplified by compounds of types (1) to (7) below.
(1) One suitable type of terminal modifier is alkoxysilyl group-bearing compounds. Alkoxysilyl group-bearing compounds preferred for use are alkoxysilane compounds having at least one epoxy group or isocyanate group on the molecule. Illustrative examples include epoxy group-bearing alkoxysilanes such as
3-glycidyloxypropyltrimethoxysilane,
3-glycidyloxypropyltriethoxysilane,
(3-glycidyloxypropyl)methyldimethoxysilane,
(3-glycidyloxypropyl)methyldiethoxysilane,
β-(3,4-epoxycyclohexyl)trimethoxysilane,
β-(3,4-epoxycyclohexyl)triethoxysilane,
β-(3,4-epoxycyclohexyl)methyldimethoxysilane,
β-(3,4-epoxycyclohexyl)ethyldimethoxysilane,
   condensation products of 3-glycidyloxypropyl-trimethoxysilane, and
   condensation products of (3-glycidyloxypropyl)methyl-dimethoxysilane; and
   isocyanate group-bearing alkoxysilane compounds such as
3-isocyanatopropyltrimethoxysilane,
3-isocyanatopropyltriethoxysilane,
(3-isocyanatopropyl)methyldimethoxysilane,
(3-isocyanatopropyl)methyldiethoxysilane,
   condensation products of 3-isocyanatopropyl-trimethoxysilane and
   condensation products of (3-isocyanatopropyl)methyl-dimethoxysilane.
      A Lewis acid may be added to accelerate the reaction when the active end groups on the polymer are reacted with the above alkoxysilyl group-bearing compound. The Lewis acid acts as a catalyst to accelerate the coupling reaction, thus improving cold flow by the modified polymer and providing better shelf stability. Examples of suitable Lewis acids include dialkyltin dialkyl malates, dialkyltin dicarboxylates and aluminum trialkoxides.
      Other types of terminal modifiers that may be used include:
(2) halogenated organometallic compounds, halogenated metallic compounds and ester or carbonyl group-bearing organometallic compounds of the general formulas R⁵ₚM′X₄₋ₚ, M′X₄, M′X₃, R⁵ₚM′(—R⁶—COOR⁷)₄₋ₚ or R⁵ₚM′(—R⁶—COR⁷)₄₋ₚ (wherein R⁵ and R⁶ are each independently a hydrocarbon group of 1 to 20 carbons; R⁷ is a hydrocarbon group of 1 to 20 carbons which may contain a pendant carbonyl or ester group; M′ is a tin, silicon, germanium or phosphorus atom; X is a halogen atom; and the letter p is an integer from 0 to 3);
(3) heterocumulene compounds having on the molecule a Y═C═Z linkage (wherein Y is a carbon, oxygen, nitrogen or sulfur atom; and Z is an oxygen, nitrogen or sulfur atom);
(4) three-membered heterocyclic compounds containing on the molecule a bond of the following formula

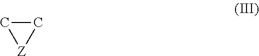

(wherein Z is an oxygen, nitrogen or sulfur atom);
(5) halogenated isocyano compounds;
(6) carboxylic acids, acid halides, ester compounds, carbonate compounds and acid anhydrides of the formula R⁸—(COOH)_{q}, R⁹(COX)_{q}, R¹⁰(COO—R¹¹)_{q}, R¹²—OCOO—R¹³, R¹⁴—(COOCO—R¹⁵)_{q} or the following formula

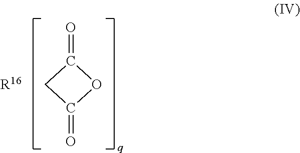

(wherein R⁸ to R¹⁶ are each independently a hydrocarbon group of 1 to 50 carbons, X is a halogen atom, and the letter q is an integer from 1 to 5); and
(7) carboxylic acid metal salts of the formula R¹⁷ᵣM″(OCOR¹⁸)₄₋ᵣ, R¹⁹ᵣM″(OCO—R²⁰—COOR²¹)₄₋ᵣ or the following formula

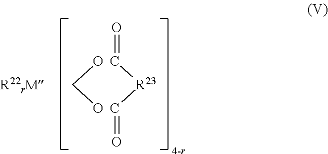

(wherein R¹⁷ to R²³ are each independently a hydrocarbon group of 1 to 20 carbons, M″ is a tin, silicon or germanium atom, and the letter r is an integer from 0 to 3).

Specific examples of the above terminal modifiers and methods for their reaction are described in, for example, JP-A 11-35633, JP-A 7-268132 and JP-A 2002-293996.

Of the catalysts mentioned above, rare-earth catalysts, and particularly neodymium catalysts, are preferred.

Above component A is a base rubber composed primarily of a polybutadiene such as that described above. The content of the polybutadiene serving as the main ingredient in the base rubber is typically at least 60 wt %, preferably at least 70 wt %, and more preferably at least 80 wt %. The above-described polybutadiene may account for 100 wt % of the base rubber, although the content may be set to 95 wt % or less, or even to 90 wt % or less. At a polybutadiene content below 60 wt %, the ball rebound may worsen.

Rubber ingredients other than polybutadiene which may be included in above component A are exemplified by styrene-butadiene rubbers, natural rubbers, isoprene rubbers and ethylene-propylene-diene rubbers.

Rubber ingredients other than the above-described polybutadiene in the base rubber account for the balance of the base rubber exclusive of the content of the polybutadiene, and are included in an amount of preferably 40 wt % or less, more preferably 30 wt % or less, and even more preferably 20 wt % or less.

Next, the organic peroxide serving as component B is exemplified by dicumyl peroxide, 1,1-bis(t-butylperoxy)-3,5,5-trimethylcyclohexane and α,α′-bis(t-butylperoxy)diisopropylbenzene. The organic peroxide may be a commercial product, illustrative examples of which include Percumyl D (available from NOF Corporation), Perhexa 3M (NOF Corporation), and Luperco 231XL (Atochem Co.). These may be used singly or as mixtures of two or more.

The amount of the organic peroxide included per 100 parts by weight of component A, although not particularly limited, may be set to preferably at least 0.1 part by weight, more preferably at least 0.2 part by weight, and even more preferably at least 0.3 part by weight. No particular upper limit is imposed on the amount of the organic peroxide per 100 parts by weight of component A, although this amount is preferably not more than 10 parts by weight, more preferably not more than 5 parts by weight, and even more preferably not more than 2 parts by weight. If too little component B is included, the time required for crosslinking increases, which may result in a large decline in productivity and may also significantly lower the compression of the ball. If too much is included, the ball rebound and durability may decrease.

The unsaturated carboxylic acid and/or metal salt thereof serving as component C is exemplified by unsaturated carboxylic acids such as acrylic acid, methacrylic acid, maleic acid and fumaric acid. Acrylic acid and methacrylic acid are especially preferred. Metal salts of unsaturated carboxylic acids are exemplified by zinc salts and magnesium salts. Of these, preferred use may be made of zinc acrylate.

The amount of component C included per 100 parts by weight of component A, although not particularly limited, may be set to preferably at least 10 parts by weight, more preferably at least 15 parts by weight, and even more preferably at least 20 parts by weight. No particular upper limit is imposed on the amount of component C per 100 parts by weight of component A, although this amount is preferably not more than 60 parts by weight, more preferably not more than 50 parts by weight, even more preferably not more than 45 parts by weight, and most preferably not more than 40 parts by weight. At an amount of component C outside the above range, the ball rebound may decrease and the feel on impact may worsen.

The organosulfur compound serving as component D is an optional ingredient for increasing the ball rebound, and is exemplified by thiophenols, thionaphthols, halogenated thiophenols, and metal salts thereof. Illustrative examples include pentachlorothiophenol, pentafluorothiophenol, pentabromothiophenol, p-chlorothiophenol and zinc salts thereof; and also diphenylpolysulfides, dibenzylpolysulfides, dibenzoylpolysulfides, dibenzothiazoylpolysulfides and dithiobenzoylpolysulfides having 2 to 4 sulfurs, alkylphenyldisulfides, sulfur compounds having a furan ring, and sulfur compounds having a thiophene ring. The use of a diphenyldisulfide or the zinc salt of pentachlorothiophenol is especially preferred.

The amount of component D included per 100 parts by weight of component A, although not particularly limited, may be set to preferably at least 0.1 part by weight, more preferably at least 0.2 part by weight, even more preferably at least 0.4 part by weight, and most preferably at least 0.5 part by weight. No particular upper limit is imposed on the amount of component D per 100 parts by weight of component A, although this amount is preferably not more than 10 parts by weight, more preferably not more than 5 parts by weight, and even more preferably not more than 3 parts by weight. If too little component D is included, the rebound-improving effects may vanish. On the other hand, too much component D may excessively lower the hardness, as a result of which a sufficient rebound may not be obtained.

The inorganic filler serving as component E is exemplified by zinc oxide, barium sulfate and calcium carbonate. The amount of component included per 100 parts by weight of component A, although not particularly limited, may be set to preferably at least 3 parts by weight, more preferably at least 5 parts by weight, and even more preferably at least 8 parts by weight. No particular upper limit is imposed on the amount of inorganic filler included per 100 parts by weight of component A, although this amount is preferably not more than 80 parts by weight, more preferably not more than 65 parts by weight, and even more preferably not more than 50 parts by weight. Too much or too little component E may make it impossible to achieve a suitable weight and a good rebound.

The rubber composition containing above components A to E may also optionally include an antioxidant. The amount of antioxidant included per 100 parts by weight of component A, although not particularly limited, may be set to preferably at least 0.05 part by weight, more preferably at least 0.1 part by weight, and even more preferably at least 0.2 part by weight. No particular upper limit is imposed on the amount of the antioxidant included, although this amount is preferably set to not more than 5 parts by weight, more preferably not more than 3 parts by weight, and even more preferably not more than 1 part by weight. The antioxidant may be a commercial product, illustrative examples of which include Nocrac NS-6 and Nocrac NS-30 (both available from Ouchi Shinko Chemical Industry Co., Ltd.), and Yoshinox 425 (Yoshitomi Pharmaceutical Industries, Ltd.).

When a solid core is formed using the above rubber composition, formation may be carried out through vulcanization and curing by a method similar to that used for known golf ball rubber compositions. Vulcanization may be carried out under, for example, the following vulcanization conditions: a vulcanization temperature of 100 to 200° C., and a vulcanization time of 10 to 40 minutes.

The local hardnesses of the solid core formed as described above may be suitably adjusted and are not subject to any particular limitation. For example, the solid core may be given a local hardness distribution in which the hardness from the center to the surface of the molded material is generally the same or in which there is a hardness difference from the center to the surface of the molded material.

The solid core obtained in the core-forming step may be set to a diameter of preferably at least 35 mm, and more preferably at least 37 mm. The diameter, although not subject to any particular upper limit, is preferably not more than 42 mm, more preferably not more than 41 mm, and even more preferably not more than 40 mm. If the diameter of the solid core is too small, the feel and rebound of the ball may worsen, whereas if the diameter is too large, the durability to cracking may worsen.

The solid core has a deflection which is not subject to any particular limitation, although the deflection of the solid core when compressed under a final load of 1,275 N (130 kgf) from an initial load state of 98 N (10 kgf) may be set to at least 2.0 mm, and preferably at least 3.0 mm. No particular upper limit is imposed on the deflection, although the deflection is typically not more than 5.5 mm, and preferably not more than 5.0 mm. A deflection of less than 2.0 mm may worsen the feel of the ball on impact and, particularly on long shots with a driver in which the ball incurs a large deformation, may subject the ball to an excessive rise in spin, shortening the distance traveled by the ball. On the other hand, a deflection of more than 5.5 mm may deaden the feel of the ball when played and lower the rebound of the ball, resulting in a shorter distance, and moreover may give the ball a poor durability to cracking on repeated impact.

The solid core has a specific gravity which, although not subject to any particular limitation, may be set to preferably at least 0.9, more preferably at least 1.0, and even more preferably at least 1.1. Although the specific gravity of the core has no particular upper limit, it is recommended that the specific gravity be not more than 1.4, preferably not more than 1.3, and even more preferably not more than 1.2.

Next, the solid core that was formed in the core-forming step is surface-treated using a treatment solution which is an aqueous solution containing a haloisocyanuric acid and/or a metal salt thereof. This surface treatment step using an aqueous solution of a haloisocyanuric acid and/or a metal salt thereof is described in detail below.

First, the haloisocyanuric acid and/or metal salt thereof which may be used in the surface treatment step is a compound of the following formula (VI).

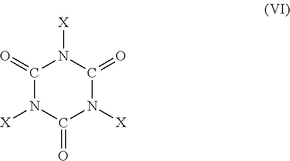

In the formula, X is a hydrogen atom, a halogen atom or an alkali metal atom. At least one occurrence of X is a halogen atom. Preferred halogen atoms include fluorine, chlorine and bromine, with chlorine being especially preferred. Preferred alkali metal atoms include lithium, sodium and potassium.

Illustrative examples of the haloisocyanuric acid and/or metal salt thereof include chloroisocyanuric acid, sodium chloroisocyanurate, potassium chloroisocyanurate, dichloroisocyanuric acid, sodium dichloroisocyanurate, sodium dichloroisocyanurate dihydrate, potassium dichloroisocyanurate, trichloroisocyanuric acid, tribromoisocyanuric acid, dibromoisocyanuric acid, bromoisocyanuric acid, sodium and other salts of dibromisocyanuric acid as well as hydrates thereof, and difluoroisocyanuric acid. Of these, chloroisocyanuric acid, sodium chloroisocyanurate, potassium chloroisocyanurate, dichloroisocyanuric acid, sodium dichloroisocyanurate, potassium dichloroisocyanurate and trichloroisocyanuric acid are preferred because they are easily hydrolyzed by water to form acid and chlorine, and thus function as an initiator of addition reactions to the double bonds on the diene rubber molecule. In this invention, preferred use can be made of dichloroisocyanuric acid and sodium dichloroisocyanurate in particular because these have high solubilities in water and readily react with the core surface.

In the surface treatment step, an aqueous solution of the above haloisocyanuric acid and/or metal salt thereof is used as the treatment solution. In this invention, using water as the solvent for the treatment solution makes it possible to reduce the burden on the environment compared with the conventional use of organic solvents such as acetone. Moreover, because water is readily available and inexpensive, this is desirable not only in terms of the environment but also from a manufacturing standpoint. Furthermore, many organic solvents such as acetone have been designated as hazardous substances, whereas water has not and is thus easy to handle.

The content of the haloisocyanuric acid and/or a metal salt thereof in the treatment solution per 100 parts by weight of water is not subject to any particular limitation, but may be set to preferably at least 0.5 part by weight, more preferably at least 1 part by weight, and even more preferably at least 3 parts by weight. If the content of the haloisocyanuric acid and/or a metal salt thereof is too low, the adhesion improving effects expected following core surface treatment may not be achieved, possibly resulting in a poor durability to impact. The upper limit in the content is the saturated solution concentration. However, from the standpoint of cost effectiveness, it is preferable to limit the content to not more than about 10 parts by weight per 100 parts by weight of water.

Methods that may be used to treat the core surface with the above treatment solution are exemplified by methods which involve coating the surface of the core with the aqueous solution by brushing or spraying on the solution, and methods in which the core is immersed in the treatment solution. From the standpoint of productivity and for high penetrability of the core surface by the solution, the use of an immersion method is especially preferred. When an immersion method is employed, the core immersion time in the treatment solution, although not particularly limited, may be set to preferably at least 0.3 second, more preferably at least 3 seconds, and even more preferably at least 10 seconds, but is preferably not more than 5 minutes, and more preferably not more than 4 minutes. If the immersion time is too short, the desired treatment effects may not be obtained, whereas a long immersion time may result in a loss of productivity.

Prior to carrying out the above surface treatment on the solid core, adhesion between the core surface and the adjoining cover material can be further enhanced by carrying out an abrasion step that involves abrading the surface of the core.

Carrying out such an abrasion step removes the skin layer from the surface of the vulcanized core, and thus makes it possible to enhance the ability of the treatment solution to penetrate the core surface and also to increase the surface area of contact with the adjoining cover material. Exemplary methods of abrasion include buffing, barrel grinding and centerless grinding.

The solid core that has been surface treated as described above is then washed to remove excess treatment solution adhering to the surface. The washing step is described below in detail.

In the washing step, water or an aqueous solution containing a lower concentration of a haloisocyanuric acid and/or a metal salt thereof than the treatment solution used in the surface treatment step may be employed as the washing fluid. In the practice of the invention, to enhance the durability of the ball to impact while maintaining a good appearance, preferred use may be made of an aqueous solution containing a lower concentration of a haloisocyanuric acid and/or a metal salt thereof than the treatment solution used in the surface treatment step. The use of an aqueous solution containing dichloroisocyanuric acid or sodium dichloroisocyanurate as the washing fluid is even more preferred.

The content of the haloisocyanuric acid and/or a metal salt thereof in the washing fluid is not particularly limited, so long as it is lower than the concentration of the treatment solution used in the above surface treatment step. Specifically, assuming the washing fluid to have a lower concentration than the treatment solution, the washing fluid may be set to a concentration of preferably less than 3 parts by weight, and more preferably 2 parts by weight or less, per 100 parts by weight of water. If the content of the haloisocyanuric acid and/or a metal salt thereof is too high, the appearance of the ball may worsen.

In the washing step, washing of the core surface may be carried out in various ways, such as with running water, by spraying, or by soaking in a wash tank. However, because the aim here is not merely to wash, but also to initiate and promote the desired treatment reactions, too vigorous a washing method is inappropriate. Therefore, in the invention, preferred use may be made of washing by soaking in a wash tank. In such a case, it is desirable to place the surface-treated cores from about one to five times in a wash tank filled with water or washing fluid of the prescribed concentration. When an aqueous solution containing a low concentration of a haloisocyanuric acid and/or a metal salt thereof is used as the washing fluid, the concentration of the solution may be optionally changed with each washing stage. For example, the concentration of the solution may be gradually lowered with each successive wash. If such washing treatment is not carried out after the surface treatment step, excess haloisocyanuric acid and/or a metal salt thereof remaining on the core surface may cause partial yellowing of the ball surface following cover formation.

In the practice of the invention, treating the surface of the core with a haloisocyanuric acid and/or a metal salt thereof greatly improves adhesion with the cover. The reason, while not entirely clear, is thought to be as follows.

First, the haloisocyanuric acid and/or a metal salt thereof, together with the solvent, penetrates to the interior of the diene rubber making up the core and approaches the vicinity of the double bonds on the main chain. Water then enters the core surface, whereupon the haloisocyanuric acid and/or a metal salt thereof is hydrolyzed by the water, releasing the halogen. The halogen attacks the double bonds on the diene rubber main chain located nearby, as a result of which an addition reaction proceeds. In the course of this addition reaction, the liberated isocyanuric acid is added, together with the halogen, to the diene rubber main chain while retaining its cyclic structure. The added isocyanuric acid has three —NHCO— structures on the molecule.

Because —NHCO— structures are thereby conferred to the core surface which has been treated with the haloisocyanuric acid and/or a metal salt thereof, adhesion with the cover material improves further. It is most likely because of this that the durability of the golf ball to impact improves. Moreover, by using as the cover material a polyurethane elastomer or polyamide elastomer having the same —NHCO— structures on the polymer molecule, the affinity increases even further, presumably increasing the durability to impact.

Moreover, no exothermal or endothermal peaks are confirmed from room temperature to 300° C. in differential scanning calorimetry (DSC) on the material in the surface portions of surface-treated solid core. This means that the functional groups which have been introduced maintain a stable state within this temperature range. In other words, during formation of the cover, the functional groups which have been introduced do not undergo degradation or the like due to heat, and retain their activity. Also, because melting in the manner of a hot-melt resin does not arise, deleterious effects on durability and quality of appearance, such as resin bleed out to the parting line, do not occur. In addition, the very fact that the material in the surface portion of the solid core following the surface treatment described above is stable may be regarded as evidence that the isocyanuric acid having a melting point above 300° C. has been added with its molecular structure still intact.

Next, the solid core that has been washed in the above washing step is covered with a cover material, thereby forming a cover. This cover forming step is described in detail below.

In the cover-forming step, one or more resin selected from among thermoplastic polyurethane elastomers, thermoset polyurethane resins and polyamide elastomers may be used as the primary ingredient of the cover material. These resins have in the resin skeleton the same —NHCO— molecular structures as isocyanuric acid, and thus firmly adhere by means of strong intermolecular forces to the surface of the solid core treated as described above.

The polyurethane elastomers are not particularly limited, provided they are thermoplastic resins or thermoset resins composed primarily of polyurethane. A morphology that includes soft segments composed of a high-molecular-weight polyol compound and hard segments composed of a diisocyanate and a monomolecular chain extender is preferred.

First, the thermoplastic polyurethane elastomer is described. Exemplary polymeric polyol compounds include, but are not particularly limited to, polyester polyols and polyether polyols. From the standpoint of rebound resilience or low-temperature properties, the use of a polyether polyol is preferred.

Exemplary polyether polyols include polytetramethylene glycol and polypropylene glycol. The use of polytetramethylene glycol is especially preferred. These polyether polyols have a number-average molecular weight which, although not particularly limited, may be set to preferably at least 1,000, and more preferably at least 1,500, but preferably not more than 5,000, and more preferably not more than 3,000.

Exemplary diisocyanates include, but are not particularly limited to, aromatic diisocyanates such as 4,4′-diphenylmethane diisocyanate, 2,4-toluene diisocyanate and 2,6-toluene diisocyanate; and aliphatic diisocyanates such as hexamethylene diisocyanate. In the practice of the invention, for a good reaction stability with the subsequently described isocyanate mixture when blended therewith, the use of 4,4′-diphenylmethane diisocyanate is preferred.

No particular limitation is imposed on the monomolecular chain extender, although use may be made of an ordinary polyol or polyamine. Specific examples include 1,4-butylene glycol, 1,2-ethylene glycol, 1,3-propylene glycol, 1,3-butanediol, 1,6-hexylene glycol, 2,2-dimethyl-1,3-propanediol, 1,3-butylene glycol, dicyclohexylmethylmethanediamine (hydrogenated MDA) and isophoronediamine (IPDA). These chain extenders have average molecular weights of preferably from 20 to 15,000.

A commercial product may be used as the thermoplastic polyurethane elastomer. Illustrative examples include Pandex T7298, Pandex TR3080, Pandex T8190 and Pandex T8195 (all available from DIC Bayer Polymer, Ltd.), and Resamine 2593 and Resamine 2597 (available from Dainichiseika Color & Chemicals Mfg. Co., Ltd.). These may be used singly, or two or more may be used in combination.

Other ingredients such as pigments, dispersants, antioxidants, ultraviolet absorbers, ultraviolet stabilizers and plasticizers, and also inorganic fillers (e.g., zinc oxide, barium sulfate, titanium dioxide) may be optionally compounded with these thermoplastic polyurethane elastomers.

The amount in which such additives are included per 100 parts by weight of the thermoplastic polyurethane elastomer, although not particularly limited, may be set to preferably at least 0.1 part by weight, more preferably at least 0.5 part by weight, and even more preferably at least 1 part by weight. The maximum amount, although not particularly limited, is preferably not more than 50 parts by weight, more preferably not more than 30 parts by weight, and even more preferably not more than 6 parts by weight. If the amount of additives included is too large, the durability may decrease, whereas if the amount included is too small, the desired effects of the additives may not be achieved.

The cover material has a material hardness (Shore D) which, although not particularly limited, may be set to preferably at least 40. The material hardness has no particular upper limit, but is preferably not more than 70, and more preferably not more than 60. If the material hardness is too low, the ball may have a poor rebound. On the other hand, if the material hardness is too high, improvements in the feel on impact and controllability may not be observable. In this invention, the material hardness refers to the hardness measured using a type D durometer in general accordance with ASTM D2240 for a sheet of the cover material that has been molded under pressure to a thickness of about 2 mm.

In cases where the cover is made of a thermoset polyurethane resin, the cover is obtained by covering the surface of the core with a mixture containing the main ingredients of the above-described thermoplastic polyurethane elastomer prior to reaction, then applying heat or the like to effect reactions and curing on the core surface. This differs from a thermoplastic polyurethane elastomer in that the reactions increase the size of the polymer to a molecular weight at which the polymer does not have a melting point.

Other ingredients such as pigments, dispersants, antioxidants, ultraviolet absorbers, ultraviolet stabilizers, plasticizers, inorganic fillers (e.g., zinc oxide, barium sulfate, titanium dioxide) and curing accelerators may be optionally compounded with these thermoset polyurethane resins.

The amount in which the above additives are included per 100 parts by weight of the thermoset polyurethane resin, although not particularly limited, may be set to preferably at least 0.1 part by weight, more preferably at least 0.5 part by weight, and even more preferably at least 1 part by weight. The maximum amount, although not particularly limited, is preferably not more than 50 parts by weight, more preferably not more than 30 parts by weight, and even more preferably not more than 6 parts by weight. If the amount of additives included is too large, the durability may decrease, whereas if the amount included is too small, the desired effects of the additives may not be achieved.

The polyamide elastomers are not subject to any particular limitation, provided they are thermoplastic resins having a polyamide component on the molecule. Such polyamide elastomers are characterized by having a higher rebound resilience the lower their hardness, and are therefore highly suitable for achieving a softer cover material on golf balls and for designing high-rebound golf balls.

The polyamide elastomer may be a block copolymer which includes as the hard segments a polyamide component such as nylon 6, nylon 66, nylon 11, nylon 12 or an aromatic polyamide, and which includes as the soft segments a polyoxyalkylene glycol such as polyoxytetramethylene glycol or polyoxypropylene glycol, or an aliphatic polyester.

The above cover material has a material hardness (Shore D) which, although not particularly limited, may be set to preferably at least 20, and more preferably at least 40. The hardness has no particular upper limit, but is preferably not more than 70, and more preferably not more than 60. If the material hardness is too low, the content of the polyamide component serving as the hard segments is small, resulting in a poor compatibility with the modified core surface, which may lower the adhesive strength between the layers. On the other hand, if the material hardness is too high, a good feel on impact and an improved controllability may not be obtained.

Commercially available products may be used as the polyamide elastomer. Illustrative examples include Pebax 2533, Pebax 3533 and Pebax 4033 (available from Arkema), Daiamid-PAE E40 and Daiamid-PAE E47 (Daicel-Huels, Ltd.), Grilon and Grilamid (EMS-Chemie (Japan) Ltd.), Grilux A (DIC Corporation), Novamid EL (Mitsubishi Chemical Corporation), and Ube-PAE (Ube Industries, Ltd.).

Other ingredients such as pigments, dispersants, antioxidants, ultraviolet absorbers, ultraviolet stabilizers, plasticizers, and inorganic fillers (e.g., zinc oxide, barium sulfate, titanium dioxide) may be optionally compounded with these polyamide elastomers.

The amount in which such additives are included per 100 parts by weight of the polyamide elastomer, although not particularly limited, may be set to preferably at least 0.1 part by weight, more preferably at least 0.5 part by weight, and even more preferably at least 1 part by weight. The maximum amount, although not particularly limited, is preferably not more than 50 parts by weight, more preferably not more than 30 parts by weight, and even more preferably not more than 6 parts by weight. If the amount of additives included is too large, the durability may decrease, whereas if the amount included is too small, the desired effects of the additives may not be achieved.

The above cover material exhibits a very good scuff resistance, and achieves a good feel on impact.

The golf ball obtained by the manufacturing method of the invention is a golf ball in which the cover layer adjoining the above-described core is formed of the above-described cover material. Moreover, the golf ball of the invention may be a solid two-piece golf ball composed of a solid core which has been surface-treated with the above-described treatment solution, and a one-layer cover of the above-described cover material formed on the surface of the core. Alternatively, the inventive golf ball may be a multi-piece solid golf ball having a cover of two or more layers on the core surface, which ball is obtained by using the above-described cover material to form an inner cover layer over the core surface, then using another cover material to form one or more outer cover layer outside of the inner cover layer.

The other cover material is not subject to any particular limitation, and may be any known material that is used as a cover material in golf balls. Illustrative examples include ionomer resins, polyester elastomers, polyurethane elastomers and polyamide elastomers having different physical properties than the polyurethane elastomer and polyamide elastomer used in the inner cover layer, polyolefin elastomers, and mixtures thereof.

The method used to form the cover may be a known method and is not subject to any particular limitation. For example, use may be made of a method in which a prefabricated core is placed in a mold and the cover material is melted under applied heat or mixed and melted under applied heat, then injection molded over the core.

Alternatively, a method may be used in which a pair of hemispherical half-cups are molded from the cover material, following which the half-cups are placed around the core and molded under applied pressure at 120 to 170° C. for 1 to 5 minutes. When a thermoset resin is used, a process such as RIM molding or LIM molding may be employed.

In cases where the cover is formed by an injection molding process, to ensure that the above-described cover material has a flowability which is suitable for injection molding and thus improve the moldability, it is desirable to adjust the melt flow rate of the material. In the practice of the invention, it is recommended that the melt flow rate measured at a test temperature of 190° C. and under a test load of 21.18 N (2.16 kgf) in accordance with JIS-K6760, although not subject to any particular limitation, be adjusted to generally at least 0.5 dg/min, preferably at least 1 dg/min, more preferably at least 1.5 dg/min, and even more preferably at least 2 dg/min. Although there is no particular upper limit in the melt flow rate, it is recommended that the melt flow rate be adjusted to generally not more than 20 dg/min, preferably not more than 10 dg/min, more preferably not more than 5 dg/min, and even more preferably not more than 3 dg/min. If the melt flow rate is too high or too low, the moldability may markedly decrease.

The cover formed of the above cover material has a thickness which, although not subject to any particular limitation, is preferably at least 0.5 mm, and more preferably at least 1.0 mm, but preferably not more than 4.0 mm, and more preferably not more than 2.5. If the cover thickness is too large, the rebound may decrease. On the other hand, if the cover thickness is too small, the durability may decline.

In golf balls obtained by the manufacturing method of the invention, it is desirable to form numerous dimples on the surface of the cover, and to subject the cover to various treatments, such as surface preparation, stamping and painting. Concerning the arrangement of the dimples, it is desirable for the dimples to be arranged in such a way that the surface of the ball has not even a single great circle thereon which does not intersect any dimples. The presence of a great circle which does not intersect any dimples may give rise to variability in the distance traveled by the ball.

The above dimples are preferably optimized as to the number of dimple types and the total number of dimples. The synergistic effects achieved by optimizing the number of dimples types and the total number of dimples further stabilize the trajectory of the ball, making it possible to obtain a golf ball having an excellent distance performance.

“Number of dimple types” refers herein to the number of dimple types of mutually differing diameter and/or depth. It is recommended that the number of dimple types be preferably at least two, and more preferably at least three, but preferably not more than eight, and more preferably not more than six.

The total number of dimples, although not particularly limited, may be set to preferably at least 250, and more preferably at least 300, but preferably not more than 500, and more preferably not more than 455. If the total number of dimples is too low or too high, an optimal lift may not be achieved, which may shorten the distance traveled by the ball.

In the practice of the invention, when the golf ball is painted as mentioned above, it is preferable to use a paint composition of the type disclosed in JP-A 10-234884, i.e., a golf ball paint composition containing a hydroxyl group-bearing polyester obtained by reacting a polyol component with a polybasic acid component and containing also a non-yellowing polyisocyanate, wherein at least some portion of the polyol component has an alicyclic structure within the molecule; or a paint composition of the type disclosed in JP-A 2003-253201, i.e., a golf ball paint composition containing a polyester and/or polyether-containing acrylic polyol having a hydroxyl value of 30 to 180 mg KOH/g (solids) in combination with a polyisocyanate, wherein the acrylic polyol component has a main chain composed of an acrylic polymer and side chains composed of a polyester and/or a polyether, and wherein the molar ratio [NCO]/[OH] of isocyanate groups to hydroxyl groups is from 0.5 to 1.5. Such paint compositions have an excellent cohesive failure strength, endowing them with an impact resistance that withstands repeated impact with a golf club, an abrasion resistance that withstands bunker shots, excellent resistance to grass staining, and outstanding weatherability and water resistance. Such paint compositions have been found to be capable of adhering well to the golf ball cover layer in the present invention.

The solid multilayer golf balls obtained by the manufacturing method of the invention can be made to conform to the Rules of Golf for competitive play. That is, they may be produced to a ball diameter of not less than 42.67 mm. The weight of the golf ball, although not particularly limited, may be set to generally at least 45.0 g, and preferably at least 45.2 g. The weight of the ball is not subject to any particular upper limit, although a weight of not more than 45.93 g is preferred.

The solid multilayer golf ball of the invention has the above-described core and the above-described cover, and preferably has numerous dimples on the surface of the cover. The deflection by the ball as a whole, measured as the deformation when compressed under a final load of 1,275 N (130 kgf) from an initial load state of 98 N (10 kgf), although not subject to any particular limitation, is preferably at least 2.0 mm, and more preferably at least 3.0 mm, but preferably not more than 5.0 mm, and more preferably not more than 4.5 mm. If the deflection is too small, the ball may have a poor feel and, particularly on long shots such as with a driver in which large deformation of the ball occurs, may subject the ball to an excessive rise in spin, shortening the distance traveled by the ball. On the other hand, a deflection which is too large may deaden the feel of the ball when played and give the ball an insufficient rebound, resulting in a shorter distance, and may also give the ball a poor durability to cracking with repeated impact.

The inventive method of manufacturing golf balls, by treating the surface of a core formed of a rubber composition with an aqueous solution containing a haloisocyanuric acid and/or a metal salt thereof, is able to greatly improve adhesion between the core surface and the cover, making it possible to obtain golf balls having a very high durability to impact. Furthermore, by using water as the solvent in the treatment solution, the burden on the environment is minimized. Also, in such cases, by using a cover material composed primarily of urethane resin or polyamide resin to form the cover, solid golf balls endowed with an outstanding feel on impact and scuff resistance compared with conventional golf balls can be obtained.

### EXAMPLES

The following Examples and Comparative Examples are provided to illustrate the invention, and are not intended to limit the scope thereof.

### Examples 1 to 10, Comparative Examples 1 to 3

Solid cores having a diameter of 39.3 mm were produced by preparing the rubber compositions shown in Table 1, then molding and vulcanizing the compositions at 155° C. for 17 minutes. The surfaces of the solid cores were then abraded by centerless grinding.

TABLE 1

| | Formulation (parts by weight) |
|---|---|
| BR01 | 20 |
| BR51 | 80 |
| Zinc oxide | 4 |
| Barium sulfate | 5.4 |
| Nocrac NS-6 | 0.2 |
| Zinc salt of pentachlorothiophenol | 0.6 |
| Zinc acrylate | 33 |
| Percumyl D | 0.3 |
| Perhexa 3M-40 | 0.3 |

Details on the ingredients in Table 1 are provided below.
BR01: polybutadiene rubber synthesized with a nickel catalyst, available from JSR Corporation; cis-1,4 bond content, 95%; Mooney viscosity (ML₁₊₄ (100° C.)), 45; molecular weight distribution Mw/Mn, 4.1.
BR51: A polybutadiene rubber synthesized with a neodymium catalyst, available from JSR Corporation; cis-1,4 bond content, 95%; Mooney viscosity (ML₁₊₄ (100° C.)), 38; molecular weight distribution Mw/Mn, 2.8.
Zinc oxide: Available under the trade name “Grade 3 Zinc Oxide” from Sakai Chemical Co., Ltd.
Barium sulfate: Available under the trade name “Precipitated Barium Sulfate #100” from Sakai Chemical Co., Ltd.
Nocrac NS-6: 2,2′-Methylenebis(4-methyl-6-t-butylphenol), available from Ouchi Shinko Chemical Industry Co., Ltd.
Zinc acrylate: Available from Nihon Jyoryu Kogyo Co., Ltd.
Zinc salt of pentachlorothiophenol: Available from Tokyo Chemical Industry Co., Ltd.
Percumyl D: Dicumyl oxide, available from NOF Corporation.
Perhexa 3M-40: Available from NOF Corporation. Perhexa 3M-40 is a 40% dilution. The amount of addition indicated is the actual amount of 1,1-bis(t-butylperoxy)-3,3,5-trimethylcyclohexane added.

The solid cores obtained as described above were immersed, under the conditions shown in Table 5 and 6, in a surface treatment tank filled with the treatment solution shown in Table 2.

TABLE 2

| | Formulation (parts by weight) | | |
|---|---|---|---|
| | A | B | C |
| Neo-Chlor 60G | 1 | 3 | 6 |
| Water | 100 | 100 | 100 |

Details on the ingredients in Table 2 are provided below.
Neo-Chlor 60G: Sodium dichloroisocyanurate available from Shikoku Chemicals Corporation.

Next, the surface-treated solid core was immersed under the conditions shown in Tables 5 and 6 in a wash tank filled with the washing fluid shown in Table 3. Following immersion for the prescribed periods of time, the solid cores were taken out of the tank and air dried at room temperature.

TABLE 3

| | Formulation (parts by weight) | | |
|---|---|---|---|
| | I | II | III |
| Neo-Chlor 60G | 0 | 0.5 | 1 |
| Water | 100 | 100 | 100 |

Details on the ingredients in Table 3 are provided below.
Neo-Chlor 60G: Sodium dichloroisocyanurate available from Shikoku Chemicals Corporation.

Next, the ingredients shown in Table 4 were mixed at 200° C. with a kneading-type twin-screw extruder, thereby giving a cover material in the form of pellets. The resulting cover material was injected into a mold in which the above-described solid core had been placed, and a cover having a thickness of 1.7 mm was formed, thereby producing a solid two-piece golf ball.

TABLE 4

| | Formulation (parts by weight) |
|---|---|
| Pandex T8195 | 100 |
| Titanium oxide | 3 |
| Blue pigment | 0.5 |

Details on the ingredients in Table 4 are given below.
Pandex T8195: A thermoplastic polyurethane elastomer available from DIC Bayer Polymer, Ltd.
Titanium oxide: Available from Ishihara Sangyo Kaisha, Ltd.

The performances of the golf balls produced are shown in Tables 5 and 6.

TABLE 5

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Core | Diameter (mm) | | 39.3 | 39.3 | 39.3 | 39.3 | 39.3 | 39.3 | 39.3 | 39.3 | 39.3 | 39.3 |
| | Surface | Treatment | A | A | B | B | B | C | C | C | C | C |
| | treatment | solution | | | | | | | | | | |
| | | Immersion | 120 | 120 | 120 | 120 | 240 | 120 | 120 | 120 | 60 | 90 |
| | | time (s) | | | | | | | | | | |
| | Washing | Washing | I | II | I | II | I | I | II | III | I | I |
| | | fluid | | | | | | | | | | |
| | | Immersion | 120 | 120 | 120 | 120 | 120 | 120 | 120 | 120 | 120 | 120 |
| | | time (s) | | | | | | | | | | |

| | | | | | | | | | | | |
|---|---|---|---|---|---|---|---|---|---|---|---|
| Cover | Thickness (mm) | 1.7 | 1.7 | 1.7 | 1.7 | 1.7 | 1.7 | 1.7 | 1.7 | 1.7 | 1.7 |
| | Material hardness | 45 | 45 | 45 | 45 | 45 | 45 | 45 | 45 | 45 | 45 |
| | (Shore D) | | | | | | | | | | |
| Ball | Diameter (mm) | 42.7 | 42.7 | 42.7 | 42.7 | 42.7 | 42.7 | 42.7 | 42.7 | 42.7 | 42.7 |
| | Scuff resistance | good | good | good | good | good | good | good | good | good | good |
| | Appearance (number | 0 | 0 | 0 | 0 | 0 | 0 | 0 | 0 | 0 | 0 |
| | of yellowed balls) | | | | | | | | | | |
| | Impact durability | 1,024 | 1,033 | 980 | 1,181 | 1,000 | 943 | 1,000 | 1,140 | 1,000 | 1,000 |
| | test (shots) | | | | | | | | | | |

TABLE 6

| | | | Comparative Example | | |
|---|---|---|---|---|---|
| | | | 1 | 2 | 3 |
| Core | Diameter (mm) | | 39.3 | 39.3 | 39.3 |
| | Surface treatment | Treatment solution | — | B | C |
| | | Immersion time (s) | — | 120 | 120 |
| | Washing | Washing fluid | — | — | — |
| | | Immersion time (s) | — | — | — |

| | | | | |
|---|---|---|---|---|
| Cover | Thickness (mm) | 1.7 | 1.7 | 1.7 |
| | Material hardness (Shore D) | 45 | 45 | 45 |
| Ball | Diameter (mm) | 42.7 | 42.7 | 42.7 |
| | Scuff resistance | NG | NG | NG |
| | Appearance (number of yellowed balls) | 0 | 4 | 7 |
| | Impact durability test (shots) | 484 | 911 | 1,000 |

### Evaluation of Ball Properties

### Core Diameter (mm)

Measurements were taken at five points on the surface, and the average of the measured values was determined.

### Cover Thickness (mm)

The core thickness was calculated as (ball diameter−core diameter)÷2.

### Material Hardness of Cover Material

The material hardness was measured using a type D durometer in general accordance with ASTM D2240 for a sheet of the cover material that had been molded under pressure to a thickness of about 2 mm.

### Ball Diameter (mm)

Measurements were taken at five points on non-dimple areas of the surface, and the average of the measured values was determined.

### Scuff Resistance (Peel Test)

A tensile tester that included clamps, a drive unit, a force gauge and a recorder was used as the testing apparatus.

The golf ball was mounted on a rotatable fixture and cuts in the form of a band having a width of 4±0.3 mm were made on the surface of the ball. In cases where the area of measurement includes a cover layer obtained by injection molding with a hemispherical mold, care is taken to make the cuts in such a way as to include at least one injection gate and at least one pole. Here, the term “pole” signifies a north pole or south pole relative to an equator represented by a great circle circumscribing the ball at one or a plurality of injection gates.

Next, the band was slit at the pole and about 20 mm was peeled off to enable the band to be fixed in a clamp of the tester.

The golf ball in which the cuts had been made was placed in a fixture equipped with bearings, the band-like test specimen was passed through an opening at the top of the fixture and fixed in a clamp, and tensile test measurement was carried out in a 23±2° C. environment at a testing speed of 50 mm/min. Measurement was continued until the bonded portion of the specimen separated, the point at which a load difference of at least 0.2 kgf arose being treated as the endpoint. The average value for five samples (N=5) was determined.

The scuff resistance was rated as follows from the results thus obtained.
Good: A decrease in load was not observed for any of the balls, even when the average load value for the samples was greater than 0.3 kgf.
Fair: A decrease in load was observed for one or two balls out of five at an average load value for the samples below 0.3 kgf.
NG: A decrease in load was observed for most or all of the five balls at an average load value for the samples below 0.3 kgf.

### Appearance

The surface of the ball was visually checked for changes in color immediately after cover formation (before painting). The number of samples was set to ten, and the results were expressed as the number of balls (from among the ten samples) which exhibited yellowing.

### Durability to Impact

The durability of the golf ball was evaluated using an ADC Ball COR Durability Tester produced by Automated Design Corporation (U.S.). This tester functions so as to fire a golf ball pneumatically and cause it to repeatedly strike two metal plates arranged in parallel. The incident velocity against the metal plates was set at 43 m/s. For each type of ball, the durability of the ball was expressed as the total number of shots taken with the ball when the initial velocity fell to 97% of the average initial velocity for the first ten shots. Each of the results shown in Tables 5 and 6 is the average value for five golf balls (N=5).

Japanese Patent Application No. 2011-282762 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of manufacturing a golf ball having a solid core formed of a rubber composition and a cover of one or more layer encasing the core, the method comprising the steps of:
forming a solid core;
treating a surface of the core using a treatment solution which is an aqueous solution containing a haloisocyanuric acid and/or a metal salt thereof;
washing the surface of the surface-treated core with a washing fluid; and
forming a cover by covering the washed surface of the core with a cover material.

2. The method of claim 1, further comprising the step of, prior to the surface treatment step, abrading the surface of the core.

3. The method of claim 1, wherein an aqueous solution containing dichloroisocyanuric acid or sodium dichloroisocyanurate is used as the treatment solution in the surface treatment step.

4. The method of claim 1, wherein water or an aqueous solution containing a lower concentration of a haloisocyanuric acid and/or a metal salt thereof than the treatment solution used in the surface treatment step is used as the washing fluid in the washing step.

5. The method of claim 4, wherein an aqueous solution containing dichloroisocyanuric acid or sodium dichloroisocyanurate is used as the washing fluid in the washing step.

6. The method of claim 1, wherein the core is formed of a rubber composition composed primarily of a diene rubber.

7. The method of claim 1, wherein the cover has a layer adjoining the core, which layer is formed of a material composed primarily of one or more selected from the group consisting of thermoplastic polyurethane elastomers, thermoset polyurethane resins and polyamide elastomers.

8. The method of claim 1, wherein the surface treatment step is carried out by an immersion method.

9. The method of claim 1, wherein the washing step is carried out by an immersion method.

10. A golf ball having a solid core formed of a rubber composition and a cover of one or more layer encasing the core, which ball is manufactured by the method of claim 1.
